(19) United States
(12) Patent Application Publication
(10) Pub. No.: US 2026/0218685 A1
(43) Pub. Date: Jul. 30, 2026

(54) DEVELOPMENTS TO FLYWHEEL ENERGY STORAGE

(71) Applicant: Thaleron Limited, Woking (GB)

(72) Inventor: Jorgen Egil Tveit, Woking (GB)

(73) Assignee: Thaleron Limited, Woking (GB)

(21) Appl. No.: 19/148,460

(22) PCT Filed: Jan. 19, 2024
(86) PCT No.: PCT/EP2024/051217

§ 371 Date: Jul. 16, 2025

(30) Foreign Application Priority Data
Jan. 20, 2023 (GB) 2300883.2

(51) Int. Cl. F03G 3/08; H02K 7/02

(52) U.S. Cl. CPC F03G 3/08; H02K 7/02

(57) ABSTRACT

There is provided embodiments of a flywheel energy storage system configured to be installed in an existing, naturally high-pressure environment, and configured to use the pressure of the environment to compress a flywheel rotor to increase its energy storage capacity. There is also provided embodiments of a rotor for use with a flywheel energy storage system, the rotor comprising a shell layer encasing the rotor and able to rotate freely to reduce the effect of frictional drag on the rotor.

The invention relates to a flywheel energy storage device, a rotor for use in a flywheel energy storage device, and a method for generating electricity using the flywheel energy storage device.

### BACKGROUND

Flywheels have been used to store energy for many years as they are highly efficient, have a long service life, and the energy stored in them is very cheap to extract.

Typically, a flywheel comprises a solid rotor, usually having a cylindrical shape, which is coupled to the shaft of an electric motor. The electric motor converts electrical energy into kinetic energy as it rotates the rotor, the energy being stored in the flywheel as angular kinetic energy. This rotational energy can then be converted back to electrical energy by driving the motor with the flywheel, thereby causing the motor to act as a generator.

To improve the efficiency of the system, the rotor is typically contained within a housing held at or near a vacuum. In this way, the frictional drag acting on the rotor, and hence energy loss, is reduced and the efficiency of the flywheel storage device is increased.

As the maximum rate of rotation of a flywheel, and hence the maximum kinetic energy that can be stored in it, is a function of the tensile strength of the material used to make the flywheel, flywheel rotors are typically required to be made of high tensile strength materials in order to store a meaningful amount of energy. In most commercial settings, this means that rotors are made of materials such as steel, aluminium, carbon fibre, or glass fibre that are often rare, hard to process, are highly carbon intensive, and have high material cost. Consequently, adding additional storage capacity by increasing the mass of the rotor as required for longer duration storage can be prohibitively expensive and difficult. This means that while flywheels are used extensively for short duration storage of small amounts of energy, they have typically been ignored for longer term storage owing to the associated costs. However, almost all energy storage demand requires longer storage capability than achievable by flywheels currently on the market, because it is drawn from the requirement to smooth the diurnal fluctuations of renewable energy sources such as solar and wind. As the world shifts increasingly towards renewable energy sources in view of growing environmental pressures, there is therefore a need for a flywheel energy storage device capable of efficient and long-term energy storage. Moreover, such a system should be capable of being constructed of abundant, low cost, and less carbon intense materials, such that the flywheel energy storage device can be manufactured and deployed all over the world.

Attempts have been made to improve the storage capability of a flywheel rotor in a number of ways. For example, U.S. Ser. No. 10/281,003B2 attempts to reduce a reliance on prohibitive high tensile strength materials by using a flywheel including a cylindrical mass body including a main material with compression resistance of at least 25 MPa, such as concrete, the body being surrounded on at least one portion of the outer surface thereof with fibres, the material that makes up the fibres having a tensile strength of at least 100 Mpa. The tension of winding the fibres around the body compresses the main material and leads to the material being pre-stressed. Hence, the maximum rotational speed of the low tensile strength concrete is increased as the centripetal force that is generated by rotation of the flywheel first has to overcome this compression before the concrete is under net tension. However, as stated above, this compression is achieved in U.S. Ser. No. 10/281,003B2 by wrapping the concrete in high tensile strength fibres which negates much of the benefit of employing a low tensile strength material for the main body. Similarly, a reliance on relatively scarce high tensile strength fibres restricts this solution to regions that can both afford the expensive materials, and have the capabilities to manufacture and work with them.

U.S. Pat. No. 5,015,940A applies a similar, pre-compression principle to known high tensile strength rotors. In this case, the additional pressure is imposed by external means and is independent of the rotational motion of the article per se. For example, U.S. Pat. No. 5,015,940A describes placing the rotor inside a pressure chamber and using a gas at super-atmospheric pressure (i.e., at a pressure greater than 1 atm 1 bar) within the chamber to compress the rotor and improve the maximum storage capacity by the same mechanism as described above in relation to U.S. Ser. No. 10/281,003B2. However, any benefits of being able to store more energy in a rotor of a given mass is largely negated by the increased cost and technical difficulty of having to provide a high tensile strength pressure chamber to contain the super-atmospheric pressure of the contained gas.

There is therefore a need for a low-cost flywheel energy storage device, and in particular one with a reduced reliance on scarce, expensive, hard to work, and highly carbon intensive high tensile strength materials.

The use of super-atmospheric gas to compress a flywheel rotor creates further difficulties for a flywheel energy storage device as the gas increases the frictional drag on the rotor and thereby reduces the efficiency of energy storage. In U.S. Pat. No. 5,015,940A, losses due to interaction of a gas with a flywheel are minimised by using low viscosity gases such as hydrogen or helium. Alternatively, a drag reduction system as described in WO2007012267A1 can be employed comprising of n concentric thin-walled rigid cylindrical shells encasing a flywheel. However, the structural requirements on such a drag reduction system result in it being uneconomical when produced at scale. There is therefore a need for an improved drag reduction system for use with a flywheel energy storage device.

### SUMMARY

The present invention addresses the above deficiencies of known flywheel storage devices by using an existing, ambient source of high pressure to provide compression of a low tensile strength rotor, and thereby increase its energy storage capacity and reduce cost. For example, embodiments of the invention can be installed in high-pressure environments, such as naturally high-pressure environments, for example under the sea, in lakes, caves, or flooded mines, for example. By doing so, the pressure differential across the housing is also reduced, reducing the tensile strength requirements of the housing.

According to a first embodiment of the invention there is provided a flywheel energy storage device comprising: a housing, wherein the housing is sealed to separate an interior of the housing from an external environment; a rotor mounted on an axle within the housing, the rotor configured to rotate relative to the housing, wherein the rotor is made of low tensile strength material; a fluid contained within the housing to compress the rotor; and means for maintaining the pressure of the fluid substantially at equilibrium with the pressure of the external environment.

According to a second embodiment of the invention, there is provided a flywheel energy storage device comprising: a housing, wherein the housing is sealed to separate an interior of the housing from an external environment; a rotor mounted on an axle within the housing, the rotor configured to rotate relative to the housing; a fluid contained within the housing to compress the rotor; means for maintaining the pressure of the fluid substantially at equilibrium with or greater than the pressure of the external environment; and wherein the housing is a pressure vessel only capable of withstanding a pressure less than the pressure of the fluid. In particular, the housing of the second embodiment of the invention may be a pressure vessel that in atmospheric conditions is only capable of withstanding a pressure less than the in-situ pressure of the contained fluid, i.e., when the second embodiment of the invention is installed in an ambient high-pressure environment.

By installing a flywheel energy storage device according to the first or second embodiment of the invention in a high-pressure environment, the fluid inside the housing can be substantially equalised with the environment to place the rotor under compression and thereby increase its energy storage capacity and remove a reliance on expensive, difficult to work, and high carbon intensity high tensile strength materials. Moreover, since the fluid is at equilibrium with the environment in the first embodiment, the housing itself does not need to be a pressure vessel to maintain the super-atmospheric pressure of the contained fluid, and the structural complexity and material cost of the housing can also be reduced. Similarly, if the fluid is operated at greater than environmental pressure, as in the second embodiment, the presence of an external pressure means that the pressure differential experienced by the housing is reduced. Accordingly, the total pressure that the housing has to withstand is less than total pressure of the fluid, thereby reducing the structural requirements and associated material costs for a given operating pressure of the fluid within the housing.

In addition or alternatively, the energy storage device of the first and second embodiment may further comprise one or more of: an electric motor coupled to the axle for storing energy in the flywheel energy storage device; and a generator coupled to the axle for extracting energy from the flywheel energy storage device, thereby allowing the storage device to store electrical energy in the first and second embodiments.

In addition, the housing of the first or second embodiment may be constructed of a low tensile strength material or a material having no intrinsic tensile strength. Such materials can be used since the flywheel energy storage devices of the first and second embodiments are intended to be installed in a high-pressure environment and are not therefore required to contain the total pressure of the super-atmospheric fluid. In more detail, materials having no intrinsic tensile strength, for example concrete, can be used for the housing as the housing is pre-stressed by the ambient pressure of the environment into a state of high compression, and the pressure of the fluid contained within the housing must first overcome this compression before the housing would be under net tension. Again, this allows more readily available, cheaper, easier to work, and less carbon intense materials to be used for the housing. In this way, the first and second embodiments of the invention reduce the cost and complexity of the storage device as a whole, while still gaining the benefit of improved storage capacity by virtue of compressing the rotor using the super-atmospheric pressure of the external environment.

In addition or alternatively, the low tensile strength material of one or more of the housing and the rotor of the first and second embodiment may have a tensile strength of less than 200 Mpa. Preferably, the tensile strength of the low tensile strength material may be less than: 150 Mpa, 100 Mpa, or 75 Mpa, and optimally may be less than: 50 Mpa, 40 Mpa, 30 Mpa, 20 Mpa, 10 Mpa, or 5 Mpa. In some embodiments, the material of the rotor may comprise a material having no intrinsic tensile strength, i.e. a tensile strength of 0 Mpa.

In addition or alternatively the rotor of the first or second embodiments may be made of a ceramic. For example, one or more of cement, concrete, and clay may be used. Alternatively, the rotor may be made of a granular material encased within a sealed vessel, wherein the pressure within the vessel is maintained at a pressure less than the pressure of the fluid. Both ceramics and granular materials (such as sand) are dense and cheap materials, allowing rotors with masses greater than 1 tonne to be readily manufactured and used at relatively low cost, thereby reducing the material and manufacturing cost of the system per se as well as the energy storage cost. Moreover, by enabling very high mass rotors, these materials also improve the long-term energy storage capability of the system. These materials are also abundant and widely available, allowing the flywheel storage devices to be manufactured and installed in remote or poorer areas where specialised, high tensile strength materials are not readily available and may not be able to be worked with. Granular materials, such as sand, have no intrinsic bond between individual material grains and therefore no tensile strength. Such materials are highly abundant, cheap, have low carbon intensity, and can be compacted to form a dense bulk material. Such materials may therefore represent an ideal choice for use in manufacturing high mass flywheel rotors as used by in the present invention.

In addition or alternatively, the means for maintaining the pressure of the first and second embodiment may comprise one or more of: a pressure compensator coupled to the pressure of the external environment; and a valve system coupled to a source of pressurised fluid. Additionally or alternatively, the means for maintaining the pressure may comprise one or more of a u-tube, and a flexible membrane covering a port coupled to the interior of the housing of the storage device. A pressure compensator allows the pressure of the fluid to be maintained at equilibrium with the external environment by automatically compensating for any drop in internal pressure, thereby ensuring the pressure of the fluid is maintained at an optimal level during operation. Alternatively or additionally, the use of a valve system and a source of pressurised fluid allows greater control over the internal pressure of the housing as the fluid in the housing can be taken to greater than environmental pressure. Alternatively, a pump may also be used to achieve a pressure within the housing that is greater than the environmental pressure. In addition, embodiments comprising a source of pressurised fluid or a pump may be passive or actively controlled to control the internal pressure of the housing. For example, active control may comprise using pressure sensors and actuators to control the valve system and thereby alter the pressure of the fluid contained within the housing.

In addition or alternatively, the housing of the first or second embodiment may be sealed using one or more seals for separating sea water from the fluid, thereby ensuring that the fluid is maintained at an optimal operating pressure, and preventing ingress of sea water that may corrode or otherwise damage components within the housing.

In addition or alternatively, the fluid used in the first and second embodiment may be a low-density fluid, and optionally the density of the fluid may be less than one third of the density of the rotor.

Use of a low-density fluid improves the efficiency of the system by minimising frictional energy losses in the fluid. Moreover, by choosing the fluid based on a required density ratio with the rotor, and in particular at the claimed ratio of one third, the energy loses can be reduced to an acceptable level while still providing sufficient compression to the rotor. Optionally, the fluid may be one or more of hydrogen and helium. Alternatively or additionally, the fluid may be one or more of neon, argon, krypton, xenon, or nitrogen.

In addition or alternatively, the first and second embodiment may further comprise an electrical connector comprising a conductor for electrical communication with the energy storage device, wherein the electrical connector comprises means to isolate the conductor from sea water, optionally wherein the means comprise one or more of a seal and a dielectric fluid. The use of means to isolate the conductor from sea water ensures that storage device can be used underwater while the required electrical connections are protected from the corrosive effects of sea water. Moreover, the claimed isolation also protects the environment from the potentially high voltage electrical signal being carried by the connector, as well as protecting from short circuits and other electrical faults.

In addition or alternatively, the first and second embodiment may further comprise control electronics, for example configured to control at least the motor-generator, and comprise means to isolate the control electronics from the external environment. Optionally, the means for isolating the control electronics may comprise a sealed, air-filled canister for protecting the control electronics from sea water. Alternatively, the cannister may be filled with dielectric. By providing control electronics as an integral part of the energy storage device, the first and second embodiments can be provided as “plug and play” systems, allowing them to be readily installed in remote locations and without requiring specialists for installation. Moreover, by providing means for isolating the control electronics from the environment, the first and second embodiments can readily be installed underwater without risking water damage to the control electronics.

In addition or alternatively, the first and second embodiments may further comprise a lifting attachment for lowering the energy storage device into position underwater. The provision of a lifting attachment allows the device to be readily installed in remote, deep areas of the ocean (or other high-pressure environments) using a readily available surface mounted crane or lifting tool, for example mounted on a ship for installation. Alternatively or additionally, the lifting attachment may allow the storage device to be lowered using buoyancy to regulate the lowering of the device.

In addition or alternatively, the first and second embodiment may further comprise a handle configured to interface with a ROV, allowing installation, inspection, maintenance, and end of life removal tasks, for example, to be carried out in situ by a remote operated vehicle, thereby reducing the risk to human divers when having to carry out such tasks. Such a handle may also be coupled to the electrical connector, allowing the storage device to be readily connected to a power source by a ROV once installed underwater.

In addition or alternatively, the housing of the first and second embodiment may be configured for connection to a foundation anchor to support and stabilize the energy storage device in location, and optionally wherein the foundation anchor is one or more of: a mudmat, a caisson, or one or more piles. The use of a foundation anchor allows the storage device to be installed in areas having sub-optimal surface conditions and remain secure while in operation and spinning at a high rotational speed. Moreover, the concrete flooring typically used for surface flywheel storage devices would exert too high pressure on the loose, subsea soil. Accordingly, the use of anchoring means specifically adapted for underwater use, such as those listed above, ensure that the first and second embodiments can be properly secured and anchored in position on the sea floor.

In addition or alternatively, the first and second embodiments may further comprise a shell layer encasing the rotor and coupled to the axle via a bearing, the shell layer having a first shape, wherein the bearing allows the shell layer to rotate around the rotor about an axis of rotation that is concentric with the axle. The use of a shell layer that can rotate freely around the rotor reduces the frictional drag experienced by the rotor by reducing the velocity differential of the fluid experienced by the rotor. In this way, the shell layer improves the efficiency of the flywheel storage device and reduces the energy storage cost.

According to a third embodiment of the invention, there is provided a rotor for use in a flywheel energy storage device, the rotor comprising: a rotor; an axle coupled to the rotor; and a shell layer encasing the rotor and coupled to the axle via a bearing, the shell layer having a first shape, wherein the bearing allows the shell layer to rotate around the rotor about an axis of rotation that is concentric with the axle, and wherein the cross section of the shell layer, when drawn in a plane in which the axis of rotation lies, defines a closed, substantially convex shape having top and bottom surfaces that intersect the axis of rotation, and wherein each of the top and bottom surfaces comprise a continuous curve.

According to a fourth embodiment of the invention, there is provided a rotor for use in a flywheel energy storage device, the rotor comprising: a rotor; an axle coupled to the rotor; and a shell layer encasing the rotor and coupled to the axle via a bearing, the shell layer having a first shape, wherein the bearing allows the shell layer to rotate around the rotor about an axis of rotation that is concentric with the axle, and wherein the shell layer defines a closed three dimensional, substantially convex shape having top and bottom surfaces that intersect the axis of rotation, and wherein each of the top and bottom surfaces comprise a portion having continuous curvature.

As explained in more detail below, the use of a shell layer that can rotate freely around the rotor as provided by the third and fourth embodiments reduces the frictional drag experienced by the rotor by reducing the velocity differential of the fluid experienced by the rotor. In this way, the shell layer improves the efficiency of the flywheel storage device and reduces the energy storage cost. In addition, the particular shape of the shell layer provided by the third and fourth embodiments allows the shell layer to act as a pressure vessel and withstand the centripetal pressure generated by a fluid as it rotates with the rotor within the shall layer without the material of shell layer being uneconomically and impractically thick. As such, the use of a shell layer provided by the third and fourth embodiments improves the energy storage efficiency of the rotor by reducing the drag experienced by the rotor. The particular shape of the shell defined by these embodiments improves the storage capacity by increasing the maximum speed at which the rotor can rotate before damaging the shell layers. Specifically, and as explained below, the provision of curved surfaces on the shell layers reduces the material cost of the shell layer by allowing the pressure to be contained by tension in the material rather than a bending moment, allowing for thinner material to be used.

In addition, any previously described embodiment of the invention may comprising a plurality of concentrically nested shell layers, wherein each shell layer has a corresponding first shape, each shell layer comprising a bearing coupled to the axle, wherein the bearing is configured to allow the shell layer to rotate around the rotor, and to rotate relative to each of the other shell layers. The use of multiple, nested shell layers further reduces the drag experienced by the rotor, thereby further increasing the efficiency of energy storage and further reducing the energy storage cost.

In addition or alternatively, in any previously described embodiment of the invention the gap between concentric shell layers may be less than 30%, preferable never more than 25%, and ideally never more than 20% of the diameter of the rotor. By reducing the gaps between the layers the efficiency of the drag reduction effect is improved. Moreover, a reduction in the gap size allows smaller diameter shell layers, and hence reduces material cost. In addition, the required thickness of the shell layers at lower radius is reduced, leading to lower material costs and decreased reliance on high tensile strength materials.

In addition or alternatively, the first shape of the shell layer of any of the previously described embodiments may be defined by a hypergeometric function. The inventors have discovered that defining the shape of the shell layer with a hypergeometric function, in particular

$$h ( r ) = \frac{1}{4} \frac{{r}^{4}}{{R}_{1}^{3}} {}_{2} {F}_{1} ( \frac{1}{2} , \frac{2}{3} , \frac{5}{3} , {( \frac{r}{{R}_{1}} )}^{6} ) ,$$

can optimise the shell layer for maximising strength while reducing the required material thickness, and hence minimising material cost. Here, h(r) is the shape of a cross section of the shell layer in the plane of the axes of rotation, r is the radial distance perpendicular to the axis of rotation, R₁ is the total radius of the rotor, and ₂F₁ is the hypergeometric function.

Alternatively, the first shape of the shell layer of any of the previously described embodiments may be one of: a sphere, an ellipsoid, and a cylinder having domed top and bottom surfaces. In a similar manner to the hypergeometric function defined above, these shapes of shell layer can address the issue of centripetal pressure by virtue of their curved top and bottom surfaces. The use of a curve allows the pressure to be resisted by tension instead of a bending moment, thereby allowing thinner materials to be used and reducing the material cost of the shell layer.

In addition or alternatively, in any previously described embodiment, the shape of the rotor may correspond to the first shape of the shell layer, thereby maximising the mass of the rotor for a given volume defined by the shell layer and accordingly maximising the energy storage capacity.

In addition or alternatively, the shell layer of any previously described embodiment may be resiliently deformable and comprise a second shape when stationary, and wherein the shell is configured to deform when rotating into the first shape. For example, when stationary and in the absence of a centripetal pressure, the shell layers may sag or “deflate” into the second shape. Then, when rotating, the centripetal pressure may cause the layers to “inflate” into the first shape. In this way, an ideal shape can be achieved while accommodating deformation of the shell layer in response to an increased centripetal pressure. Moreover, by allowing the shell layer to deform in response to this pressure rather than requiring it to rigidly maintain its shape, more abundant and lower cost materials having lower rigidity can be used to form the shell layers.

In addition or alternatively, any of the previously described embodiments may further comprise a support feature configured to inhibit deformation of the shell layer towards the rotor. As the rotational speed of the shell layer decreases, and hence the centripetal pressure of the contained fluid drops, sections of the shell layer may sag under the effect of gravity into contact with the rotor. Or, in embodiments having multiple nested shell layers, a given shell layer may sag into contact with the shell layer nested within it. Such contact may create friction, which in turn may reduce the storage efficiency of the energy storage device by converting rotational kinetic energy into heat. Therefore, in some embodiments, there may additionally be provided a support feature configured to inhibit deformation of the shell layer towards to the rotor to reduce or entirely prevent contact between the rotor and shell layer when the shell layer is in the second shape. In embodiments having multiple nested shell layers, a support feature may be associated with each shell layer (such that there are an equal number of support features as shell layers, for example) so that the support feature associated with a given shell layer inhibits deformation of the given shell layer towards the shell layer nested within the given shell layer.

In addition, the support feature may comprise a portion of the top surface of the shell layer, wherein the portion of the top surface of the shell layer extends away from the rotor to couple to the bearing. By including a portion of the top surface of the shell layer that extends away from the rotor to couple to the bearing, the shell layer is better able to resist deformation towards the rotor under gravity by supporting its weight by tension in the shell layer. This is because, by extending away from the rotor, the shell layer has a component parallel to the force of gravity, which for this embodiment acts parallel to the axis of rotation. In this context, the shell layer having “a component parallel to the force of gravity” means that the decomposition of a tangent to the surface of the shell layer at the point of interest into orthogonal vectors defined as parallel and normal to the direction of gravity, results in a non-zero vector parallel to the direction of gravity.

In addition or alternatively, the support feature may comprise a reinforced section of the shell layer. For example, by reinforcing a section of the shell layer, the stiffness of that section can be increased, thereby increasing its resistance to deformation and inhibiting deformation of the shell layer towards the rotor. For example, in embodiments in which the shell layer sags under the effects of gravity in a direction parallel to the axis of rotation, the reinforced section may be proximate to the axis of rotation on the top surface and may couple the shell layer to the bearing, thereby inhibiting deformation of the top surface towards the rotor under gravity.

In addition, the reinforced section of the shell layer may comprise one or more of: a section of the shell layer having increased thickness; a section of the shell layer being constructed of a different material to the remainder of the shell layer; and a reinforcing structure coupled to a surface of the shell layer. For example, the stiffness of the shell layer may be increased by increasing the thickness of material of the shell layer. This increased thickness may be located proximate to the axis of rotation. The thickness of the material of the top and/or bottom surface of the shell layer may increase towards the axis of rotation, for example to be at a maximum thickness at the section of the top surface closest to the axis of rotation. The shell layer may alternatively or additionally be reinforced by constructing a section of the shell of a different material to the remainder of the shell layer. For example, a section of the top and/or bottom surface proximate to the axis of rotation may be constructed of a material having increased stiffness relative to the material used to construct the remainder of the shell layer. As used here, stiffness is the ability of a material to resist deformation in response to an applied force. The shell layer may alternatively or additionally be reinforced by coupling a reinforcing structure to the surface of the shell layer. As used herein, a reinforcing structure is structure added to the shell layer to increase the stiffness of the shell layer. For example, one or more of a reinforcing plate, bar, beam, rod, truss, or bracket may be coupled to the surface of the shell layer to increase its stiffness, and thereby inhibit deformation and limit contact between the shell layer and the rotor or an internally nested shell layer. Alternatively, such structures may be embedded in the shell layer. In some embodiments, the reinforcing structures may be coupled to the interior and exterior surfaces of the shell layer to sandwich the shell layer.

In addition or alternatively, the support feature may comprise a section of the shell layer having a different material structure than the remainder of the shell layer. As used herein, a “material structure” is the macroscopic arrangement of a material. By modifying the material structure, the properties of the material can be modified, for example allowing an increase in the stiffness of the material for a lower increase in weight than by simply increasing the thickness of material.

In addition, the section of the shell layer having a different material structure may comprise a material formed into a repeated cell structure. As used herein, a repeated cell structure is a macroscopic arrangement of a material into a pattern of hollow enclosures. For example, the reinforced section may comprise a material formed into a honeycomb structure, i.e., a repeated pattern of hexagons. Alternatively, the material may be formed into a repeating pattern of any suitable shape, for example triangles, squares, pentagons, heptagons, octagons, nonagons, or decagons. Alternatively, the cell structure may be irregular, for example a Voronoi tessellation. Alternatively, the shape of the cells may vary across the repeated pattern. By employing a repeated cell structure, the stiffness of the material can be improved with a reduced weight compared to a solid material of the same thickness. To further improve stiffness, a material having a repeated cell structure may be sandwiched between two reinforcing plates.

In addition or alternatively, the support feature may comprise a support structure, wherein the shell layer is configured to contact the support structure when the shell layer is in the second shape, and wherein the shell layer is configured to move away from the support structure as the shell layer deforms into the first shape. In this way, the shell layer is prevented from sagging into contact with the rotor or a shell layer nested within it as the shell layer instead sags into contact with the support structure which thereby prevents further sagging of the shell layer. However, when the shell layer is rotated up to speed and transitions into the first shape, it decouples from the support feature and can rotate independently of the support structure. By allowing the shell layer to decouple from the support structure, which as below may rotate with the shell layer, the rotating mass of the shell layer is reduced when the shell layer is up to speed, thereby reducing the kinetic energy stored in the shell layer and improving the storage efficiency of the flywheel energy storage system.

In addition, the support structure may be coupled to the axle and configured to rotate with the shell layer. For example, the support structure may be coupled to the axle via its own support bearing, separate to the bearing of the shell layer. In this example, the support structure can rotate independently of the shell layer but will rotate with the shell layer as they come into contact, which may reduce slippage and friction between the shell layer and support structure. Alternatively, the support structure may be coupled to the same bearing as the shell layer, ensuring that the support structure and shell layer always rotate at the same speed. In this way, slippage between the support structure and shell layer as they come into contact can be entirely avoided.

In addition or alternatively, the support feature may comprise a pair of magnets, wherein the pair of magnets are configured to inhibit deformation of the shell layer via magnetic repulsion between the pair of magnets. For example, one or more magnets may be coupled to the top surface of the rotor, while one or more magnets may be coupled to the interior of the top surface of the shell layer. The poles of the magnets facing each other have the same polarity, such that as the shell layer sags and the magnets come into proximity with one another, the magnets repel each other and inhibit further deflection of the shell layer towards the rotor, thereby preventing contact between the shell layer and rotor. Alternatively or in addition, the same arrangement of magnets may be used between a given shell layer and a nested shell layer positioned interior to the given shell layer.

In addition or alternatively, the support feature may be located proximate to the axis of rotation. In embodiments in which the shell layer deforms under gravity in a direction parallel to the axle, the axle itself can be used to support the shell layer and assist in preventing contact between the shell layer and rotor in a manner analogous to a tent pole supporting a tent. As used herein, “proximate to the axis of rotation” includes the support feature being located within the central 50% of the radius of the shell layer. Alternatively, the support feature may be located within the central 40%, 30%, 20% 15%, 10%, or 5% of the radius of the shell layer. Alternatively, in embodiments in which the support feature comprises a portion of the shell layer, or wherein the support feature comprises a reinforced section of the shell layer, or wherein the support feature comprises a different material structure, the support feature may be directly coupled to the bearing, such that the support feature couples the remainder of the shell layer to the bearing.

In addition or alternatively, the flywheel energy storage device of either of the first and second embodiments may comprise the rotor of the third and fourth embodiments.

According to a fifth embodiment of the invention, there is provided a method for generating electricity using the flywheel energy storage device of any preceding embodiment, the method comprising; using the rotor to turn a generator coupled to the axle of the storage device.

### BRIEF DESCRIPTION OF THE DRAWINGS

By way of example only, a description is now given with reference to the accompanying drawings, in which:

FIG. 1 shows an external view of an embodiment of a flywheel energy storage device;

FIG. 2 shows greater detail of the pressure control means of the flywheel energy device system of FIG. 1;

FIG. 3 shows an example connector assembly of the flywheel energy storage device;

FIG. 4 shows a top-down view of the energy storage device of FIG. 1;

FIG. 5 shows a cross sectional view of the flywheel energy storage device along the line A-A shown in FIG. 4, illustrating the internal components of the storage device;

FIG. 6 shows a cross sectional view of a second embodiment of the flywheel energy storage device employing an embodiment of a drag reduction rotor;

FIG. 7 illustrates an optimal shape of a shell layer of the drag reduction rotor of FIG. 6;

FIGS. 8A-D illustrate alternative shapes of the shell layer of the drag reduction rotor of FIG. 6;

FIGS. 9A and 9B illustrate the torque acting on shell layers of increasing radius and decreasing angular momentum;

FIGS. 10A and 10B illustrate the coordinate systems used to derive an optimal shape of a shell layer;

FIG. 11 illustrate the deformation of a shell layer under the effects of gravity;

FIG. 12 illustrates an embodiment of a support feature comprising a portion of the top surface of the shell layer that extends away from the rotor to couple to the bearing;

FIGS. 13A and 13B illustrate a support feature comprising a reinforced section of the shell layer;

FIGS. 14A and 14B illustrate a material utilising a repeated cell structure, and a material suitable for use as a support feature utilising the repeated cell structure material;

FIG. 15 illustrates a support feature comprising a support plate configured to rotate with the shell layer;

FIG. 16 illustrates a support feature comprising a pair of opposed magnets that inhibit deformation of the shell layer via magnetic repulsion; and

FIG. 17 illustrates a rotor and shell layer configured to rotate around an axis of rotation that is perpendicular to the force of gravity, allowing the shell layer to support itself as an arch using compression in the curved surface of the shell layer.

### DETAILED DESCRIPTION

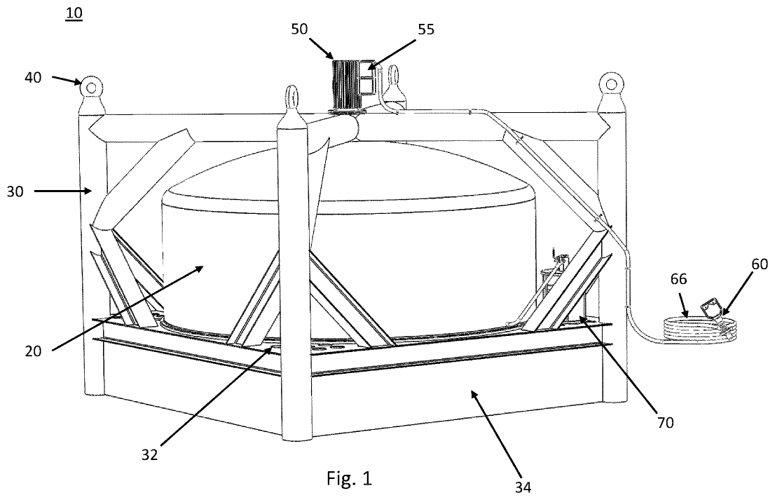

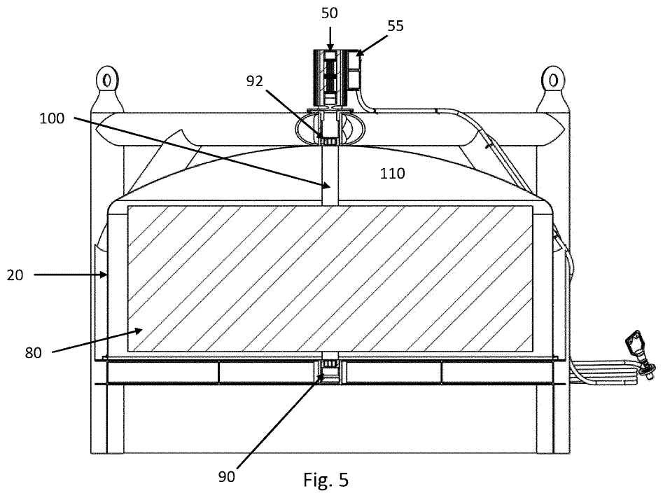

FIG. 1 shows an external view of a flywheel energy storage device 10 configured to be installed in a high-pressure environment, in accordance with an embodiment of the present invention. As shown, the storage device comprises a housing 20 which houses the flywheel rotor (as illustrated in FIG. 5) and contains a low-density fluid used to compress the rotor in situ. Storage device 10 further comprises means 70 for controlling the pressure of the fluid within housing 20 using the pressure of the external environment. For example, in the illustrated example of FIG. 1, storage device 10 comprises a pressure compensator for substantially equalising the pressure of the fluid within the housing 10 with the external environment. As is understood in the art, a pressure compensator is a component used in subsea systems to negate the effects of pressure differential at depth by balancing the internal pressure of a hydraulic system, in this instance the fluid within the housing 20, with the ambient pressure of the surrounding water.

In this way, the pressure of the external environment can be used to pressurise the fluid contained within the housing, which in turn compresses the flywheel rotor and thereby increases its energy storage capacity, as explained above. In addition, the existence of an external, high-pressure environment reduces the pressure difference experienced by the housing for a given fluid pressure, and accordingly reduces the pressure containment requirement of the housing. This means that the housing only needs to be able to withstand a pressure less than the pressure of the contained fluid, and accordingly can be constructed of cheaper, more abundant, and less carbon intense materials.

Suitable high-pressure environments include under the sea, in a lake, cave, flooded mine, or any other existing high-pressure environment. Preferably, the pressure of the external environment is greater than 10 bar, which can readily be achieved at the seabed at depths greater than 100 m.

As also shown in FIG. 1, storage device 10 further comprises a motor-generator 50 for storing energy in and extracting energy from storage device 10 by rotating the rotor. While illustrated as a combined motor-generator, storage device 10 may alternatively comprise a motor and a separate generator. Furthermore, storage device 10 may comprise only one of a motor or a generator. To store energy in storage device 10, motor-generator is operated as a motor by taking electrical power from an external power source and converting it to rotational kinetic energy of the flywheel rotor, thereby storing the electrical energy as kinetic energy. To extract energy from the storage device 10, motor-generator 50 is operated as a generator by driving it with the spinning flywheel rotor, thereby converting the kinetic energy of the rotor back into electrical energy.

In the illustrated example of FIG. 1, storage device 10 further includes control electronics 55 for controlling the motor-generator. While these are illustrated as forming an integral part of the storage device 10 in FIG. 1, control electronics 55 need not be installed on the storage device 10 and could instead be housed at a remote location and coupled to motor-generator via cabling or other forms of electronic communication. If, as in the illustrated example, control electronics are to be included in the storage device 10 and installed underwater, then storage device 10 includes means for isolating control electronics 55 from the external environment. For example, this can include housing the control electronics within a sealed, air-filled cannister to protect control electronics 55 from the corrosive effects of sea water.

As shown in FIG. 1, storage device 10 may also include a frame 30 including lifting attachments 40 for raising and lowering storage device 10 into position. As will be appreciated the pressure of the fluid within housing 20 needs to be controlled while storage device 10 is lowered into position underwater to compensate for the increasing pressure experienced by storage device with increasing depth. This can be achieved by, for example, lowering storage device along with pressure vessels (for example cylinders of pressurised fluid) coupled to the fluid within housing 20 via a valve system. While storage device 10 is being lowered using lifting attachments 40, a suitable valve system can regulate the pressure of the fluid with the pressure vessels to ensure the pressure within the housing is the same as the environment for the duration of the lowering operation. Preferably, this may be a passive system whereby the valve system opens when the pressure of the fluid within the housing 20 is less than the surrounding environment, allowing the fluid to be suitably pressurised using the pressure contained within the pressure vessels. However, as will be appreciated, the required pressure control could also be achieved using an active system comprising pressure sensors and actuators to control the valve system coupled to the pressure vessels or a pressure pump.

Frame 30 may further be configured for connection to a foundation anchor to support and stabilise storage device 10 in location. Foundations used for surface-based flywheel storage devices may not be appropriate for the surface type found in underwater environments, and storage device 10 may instead be configured to be secured in position using a mudmat, a caisson, or piles driven into the sea floor as foundations, for example. In the illustrated example of FIG. 1, storage device 10 includes a mudmat 32 and side skirts 34 coupled to frame 30.

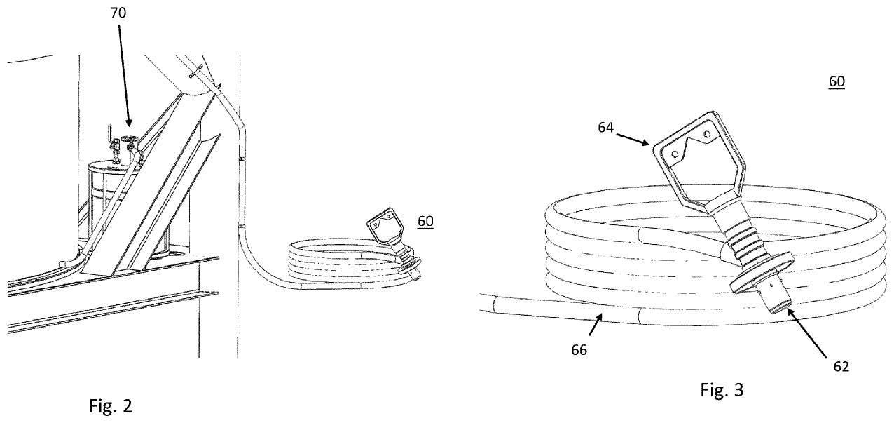

FIG. 2 shows greater detail of the pressure control means 70 and a connection assembly 60 for connecting motor-generator 50 to an external power source. As explained above, pressure control means 70 in the illustrated example of FIG. 1 is a pressure compensator, which is a passive mechanism for ensuring that the pressure of the fluid with housing 20 is substantially at equilibrium with the environment. Alternatively, or in addition to the illustrated compensator, a valve system coupled to a source of high-pressure fluid can be used to control the pressure of the fluid within housing 20. Such a valve system may be passive and regulate the fluid pressure based on the pressure of the external environment, for example by opening if the pressure of the fluid drops below that of the environment. Alternatively, the valves system may include pressure sensors and actuators to provide active control of the pressure within housing 20. As indicated above, the valve system uses a source of high-pressure fluid to control the pressure within housing 20, which may be a pressure vessel (for example a cylinder of high-pressure gas), or a pump, for example. Yet further additionally or alternatively, pressure control means may comprise one or more of a trap or U-bend (i.e., a U-shaped portion of pipe designed to trap liquid or gas) and a flexible membrane covering a port coupled to the fluid contained within the housing. The simplicity of these alternatives may be preferable in remote areas where regular maintenance may be more difficult.

FIG. 3 shows greater detail of the electrical connector assembly 60 illustrated in FIGS. 1 and 2. Electrical connector assembly 60 includes electrical connector 62, handle 64 configured for use with a remote operated vehicle (ROV), and electrical cable 66 coupled to motor generator 50 as shown in FIG. 1. As indicated above, electrical connector assembly 60 is configured for connection to an external electrical system form which energy can be stored, and into which energy extracted from storage device 10 can be injected via electrical connector 62. Electrical connector 62 may be configured for underwater connection, in which case electrical connector 62 will comprise means for isolating the electrical conductors within electrical connector 62 from the external environment. For example, this can be achieved using one or more of seals designed to prevent ingress of sea water, and/or through the use of a dielectric fluid within electrical connector 62.

As illustrated in FIG. 3, electrical connector assembly may further comprise handle 64 configured for use with a remote operated vehicle. As described above, storage device 10 may be installed at depths greater than 100 m underwater, in which case installation, inspection, maintenance, and end-of-life removal tasks associated with storage device 10 by human divers can become dangerous, expensive, and impractical. Storage device 10 may therefore be provided with a number of ROV intervention points or handles, for example handle 64 on the electrical connector assembly, that allow tasks to be carried out be ROVs, reducing the risk to human divers and allowing more regular and convenient maintenance of storage device 10.

As shown, electrical connector 62 is coupled to motor-generator 50 by cable 66, which may be a high pressure subsea electrical cable configured for use in high pressure environments. For example, cable 66 may comprise a robust sheathing, for example constructed of thermoplastics, to withstand the external pressure of the environment and protect the internal cabling from damage and abrasion from rocks and other debris that may be present where storage device is installed. Cable 66 may also contain a dielectric fluid to prevent or rapidly quench any electrical discharge that may occur from the conductor within cable 66, for example in the event that the cable is damaged.

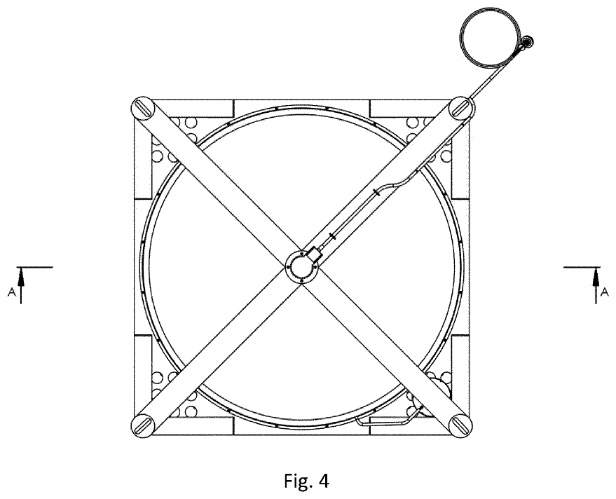

FIG. 5 illustrates a cross sectional view, along the line A-A of FIG. 4, illustrating greater detail on the internal components of flywheel energy storage device 10 in accordance with an embodiment of the present invention. As can be seen, storage device 10 comprises rotor 80 mounted on axle 100 within housing 20. Axle 100 is supported within housing via one or more bearings, which, in the illustrated example, are shown as thrust bearing 90 and radial bearing 92, allowing rotor 80 to rotate relative to housing 20. As also shown, axle 100 is coupled to motor-generator 50, allowing motor-generator 50 to rotate rotor 80 in order to store energy, and for rotor 80 to turn motor-generator 50 when energy is needed to be extracted. Fluid 110 is contained within housing 20 and pressurised using pressure control means 70 in order to place rotor 80 under compression and thereby increase the energy storage capacity of storage device 10.

As described above, it is an object of the present invention to reduce a reliance on scarce, expensive, hard to work, and highly carbon intensive high tensile strength materials for manufacture of the flywheel rotor 80, as is enabled by pre-stressing rotor 80 using the pressure of fluid 110. Accordingly, by first placing rotor 80 under compression, a wide variety of abundant, cheap, and simple to work materials may be used for manufacturing rotor 80, thus reducing the material cost and complexity of the resultant system. For example, embodiments of the present invention may employ cheap materials with low tensile strength, considered to be less than 200 Mpa, and preferably less than: 150 Mpa, 100 Mpa, or 75 Mpa. Optimally, the tensile strength may be less than: 50 Mpa, 40 Mpa, 30 Mpa, 20 Mpa, 10 Mpa, or 5 Mpa. Alternatively, rotor 80 may comprise a granular material, such as sand, having no intrinsic bond between individual material grains and therefore no tensile strength, i.e., a tensile strength of 0 Mpa. Such materials are highly abundant, cheap, have low carbon intensity, and can be compacted to form a dense bulk material. Such materials may therefore represent an ideal choice for use in manufacturing high mass flywheel rotors as used by in the present invention.

The tensile strength of a material can be determined by a number of standard tests. For example, uniaxial tensile testing can be used for determining the tensile strength of isotropic materials such as metals and plastics. Specific standard tests that can be used to determine the tensile strength of metals include ASTM E8/E8M-13, ISO 6892-1, and ISO 6892-2. Specific standard tests that can be used to determine the tensile strength of plastics include ASTM D638, ASTM D828, ASTM D882, and ISO 37. Triaxial shear testing can be used to determine the tensile strength of granular materials, such as the sand described above. For example, this can include consolidated drained or undrained testing. Specific triaxial shear test standards include ASTM D7181-11, ASTM D4767-11, ASTM D2850-03a, BS 1377-8, ISO/TS 17892-8, and ISO/TS 17892-9.

To enable a granular material having no tensile strength to form rotor 80, the granular material may be sealed within a membrane and the air within the membrane may be removed to compress the granular material into a hard, dense bulk material. Moreover, the presence of an external pressure from fluid 110 compensates for a lack of intrinsic tensile strength of the granular material by first compressing the rotor. In this way, the increasing centripetal force acting on the rotor as it is rotated at increasing speed first has to overcome this compression before the rotor is under net tension. Accordingly, a rotor comprising a low or no tensile strength material can operate as a flywheel rotor.

Using the abundant and simple to work materials described above, rotor masses of greater than 0.5 tonnes, preferably greater than 0.75 tonnes, and optimally greater than 1 tonne, can be readily achieved, thereby reducing the material and manufacturing cost of the system, as well as the energy storage cost. Moreover, the cost of adding more material to increase the mass of the rotor and thereby increase the energy storage capacity is vastly reduced compared to the high tensile strength materials traditionally used to manufacture flywheels.

As illustrated in FIG. 5, housing 20 contains fluid 110 used to compress rotor 80. Accordingly, housing 20 may comprise one or more seals (not shown) for separating the water of the external environment from fluid 110 to ensure that fluid 110 is maintained at optimal operating pressure and prevent ingress of water into the housing that may corrode or otherwise damage components within the housing.

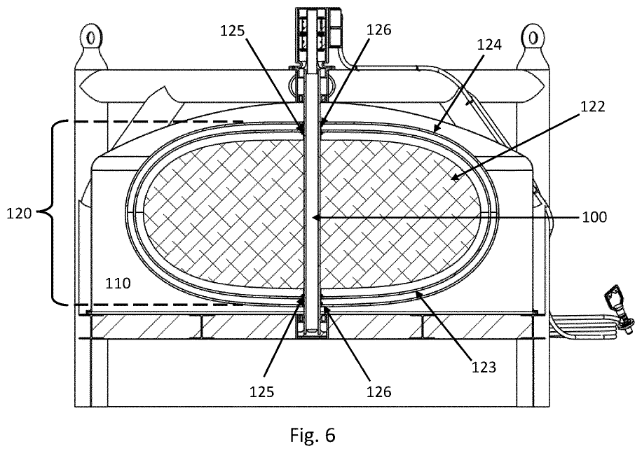

As fluid 110 is held at super-atmospheric pressures in order to compress rotor 80, the density and therefore frictional effects of fluid 110 on rotor 80 as it rotates are increased relative to fluid 110 at atmospheric pressures. Fluid 110 can therefore be chosen to minimise frictional losses and thereby improve the energy storage efficiency of storage device 10. For example, as drag increases linearly with fluid density, fluid 110 may be chosen such that the density of the fluid at operating pressure is less than the density of the rotor. In particular, the density of the fluid may be less than half the density of the rotor, and preferably may be less than: one third, one quarter, one fifth, one sixth, one seventh, or one eighth of the density of the rotor at operating pressures. For example noble gasses, such as helium, neon, argon, krypton, and xenon, may be used. Alternatively, diatomic elements such as hydrogen or nitrogen may be used as fluid 110. Furthermore, fluid 110 may be chosen to have low intrinsic viscosity (considered to be less than the viscosity of air, 18.46 μPas) to further improve energy storage efficiency. Furthermore, the use of a low density fluid ensures that the shell layers described below with reference to FIG. 6 can be made of lower tensile strength and thinner materials as the centripetal pressure exerted on the shell layers is reduced with lower fluid pressure. Hence, the use of a low density fluid as defined above further reduces the cost of the energy storage device.

As indicated, the primary purpose of fluid 110 is to compress rotor 80. To this end, as described above, the pressure of fluid 110 is controlled using pressure control means 70 and the existing pressure of the external environment in which storage device 10 is installed. For example, fluid may be pressurised to greater than 10 bar, which can readily be achieved at depths greater than 100 m below sea level, by substantially equalising fluid 110 with the external environment using pressure control means 70, for example a pressure compensator. Examples of fluid 110 being substantially at equilibrium include the pressure of fluid 110 being within 20%, preferably within 15%, and optimally within 10% of the pressure of the external environment.

Turning to FIG. 6, an embodiment of a rotor 120 to further reduce the effects of friction between the rotor and fluid 110 is illustrated. As shown, rotor 120 comprises rotor 122 similar to rotor 80 shown in FIG. 5. In addition, rotor 120 further comprises a first and second shell layer 123 and 124 encasing rotor 122 and coupled to axle 100 via first and second bearing pairs 125 and 126. Although two shell layers are illustrated in the example of FIG. 6, it will be appreciated that any number of shell layers may be used. Using first and second bearing pairs 125 and 126, first and second shell layers 123 and 124 are configured to rotate freely around rotor 122 about an axis of rotation that is concentric with axle 100.

As will be appreciated, as rotor 120 is rotated by motor-generator 50, energy is stored both in the rotor 122 and in the rotating shell layers 123, 124. Accordingly, it is preferable to ensure that the mass of the shell layers is minimised, and the efficiency of bearings 125 and 126 maximised, in order to minimise the energy lost to the shell layers. For example, by using thin, low mass shell layers (relative to the mass of rotor 122), the energy lost to the shell layers may be less than 1% of the total stored energy.

How the shell layers work to reduce the friction experienced by the rotor is explained below with reference to a single cylindrical shell layer positioned equidistant between the stationary housing 20 and spinning rotor 122. The single layer will start to rotate until the fluid friction on either face is equal, which occurs when the speed of the shell layer is halfway between the rotor speed and the housing speed, i.e., half the speed of the rotor, for a shell layer positioned equidistant between the rotor and housing. Since drag increases with velocity squared, and the velocity difference of the fluid experienced by rotor 122 is now halved, the drag experienced by rotor 122 is quartered by the use of a single shell layer. As will be appreciated, the equilibrium speed of the single shell layer will vary with its location between the rotor surface and housing. For example, the equilibrium speed of the shell layer will be higher for a shell layer positioned closer to the rotor surface, relative to a shell layer positioned at an equilibrium distance between the rotor and housing.

In greater detail, skin friction drag acts on the surface of rotor 122 as it rotates in the presence of fluid 110. The skin friction exerts a torque, τ, on the rotor

$$d τ = rdF$$

where r is the radial distance perpendicular to the axis of rotation, and dF is the differential frictional force element defined as

$$dF = {C}_{f} \frac{1}{2} ρ {( r ω )}^{2} dA ,$$

C_{f} is the friction constant,

$${C}_{f} \frac{1}{2} ρ {( r ω )}^{2}$$

is the dynamic pressure, and dA is an area element.

Considering a cylinder, we can write down a frictional force element for both the sides and the tops of the rotor:

$${dF}_{cyl , side} = {C}_{f} \frac{1}{2} ρ {R}_{1}^{2} {ω}^{2} 2 π {R}_{1} dh = {C}_{f} π ρ {ω}^{2} {R}_{1}^{3} dh ,$$

$${dF}_{cyl , top} = {C}_{f} \frac{1}{2} ρ {r}^{2} {ω}^{2} 2 π rdr = {C}_{f} π ρ {ω}^{2} {r}^{3} dr ,$$

with corresponding torques

$${T}_{cyl , side} = {\int }_{0}^{H} {C}_{f} π ρ {ω}^{2} {R}_{1}^{4} dh = {C}_{f} π ρ {ω}^{2} {R}_{1}^{4} H ,$$

$${T}_{cyl , top} = {\int }_{0}^{{R}_{1}} {C}_{f} π ρ {ω}^{2} {r}^{4} dr = \frac{1}{5} {C}_{f} π ρ {ω}^{2} {R}_{1}^{5} ,$$

where ρ is the rotor density, ω is the angular velocity of the rotor as a function of time, H is the total height of the rotor, and R₁ is the total radius of the rotor. From these equations the total drag from skin friction can be computed as

$${τ}_{cyl} = {τ}_{cyl , side} + 2 {τ}_{cyl , top} .$$

The value of C_{f} is derived empirically. For coaxially rotating cylinders, an expression for C_{f} can be found in terms of the cylinder radius, separation (s), and the Couette Reynolds number (Rₑ),

$${c}_{f} = 0.0 \; 325 {( \frac{s}{{R}_{1}} )}^{0.3} {Re}^{- 0.2}$$

$$Re = \frac{ρω {R}_{1} s}{μ} .$$

Here μ is the dynamic viscosity of the containment fluid.

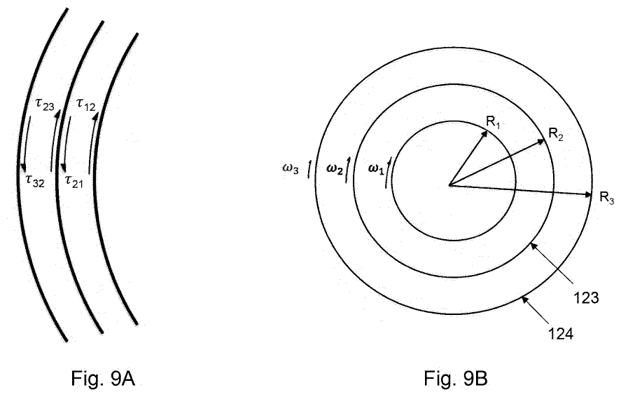

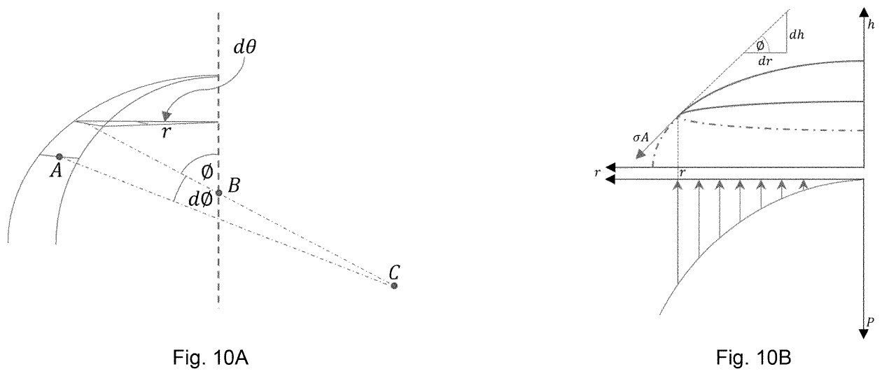

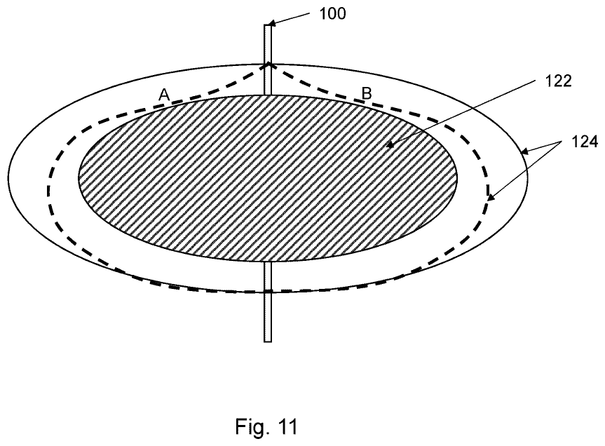

With reference to FIGS. 6, 9A, and 9B, the drag reduction system consists of shell layers 123, 124 that are free to rotate. To elucidate this, the torque on the sides of the cylindrical rotor can be considered. Here we have the expression, as derived above,

$${τ}_{cyl , side} = 0.0 \; 325 π {s}^{0.1} {μ}^{0.2} {ρ}^{0.8} H {ω}^{1.8} {R}_{1}^{3.5} = α {ω}^{1.8} ,$$

where α is a constant which subsumes the pre-factors that depend on the geometry. Now, if shell layers are inserted around the rotor, and these shell layers are allowed to freely rotate, an equilibrium will be reached. This equilibrium involves the rotor and the shell layers exerting equal but opposite torques on each other, and the shell layers and the housing doing the same. In the schematic illustration of FIGS. 10A and 10B, this geometry is displayed looking down the rotational axis.

A system of equations can be set up using τ_{i, j}=αᵢ(ωᵢ−ωⱼ)^{1.8} where the subscripts denote the rotor, divider, and housing in increasing radius. τ_{1,2}, for example, represents the torque from the shell layer on the rotor, while τ_{3,2} represents the torque from the first shell layer on the second.

Considering the case of one divider, τ_{1,2}=τ_{2,1} and τ_{2,3}=τ_{3,2}. For equilibrium, τ_{2,1}=τ_{2,3}. Setting the housing to have zero angular velocity, this gives us

$${τ}_{1 , 2} = {{α}_{1} ( {ω}_{1} - {ω}_{2} )}^{1.8} ,$$

$${τ}_{2 , 3} = {{α}_{2} ( {ω}_{2} )}^{1.8} ,$$

Equating these expressions and rearranging gives

$${ω}_{2}^{N = 1} = \frac{{ω}_{1}}{1 + {( \frac{{α}_{2}}{{α}_{1}} )}^{1 / 1.8}} ,$$

Using this value, an expression for the torque in the presence of one shell layer is given as

$${T}_{1 , 2} = {α}_{1} {{ω}_{1}^{1.8} ( 1 - \frac{1}{1 + {( \frac{{α}_{2}}{{α}_{1}} )}^{1 / 1.8}} )}^{1.8} .$$

This result shows how shell layers give rise to a torque-reduction factor. Continuing in a similar way, the case of two shell layers can be considered. The equilibrium equations may be extended to have τ_{1,2}=τ_{2,3}=τ_{3,4} and the torques are

$${τ}_{1 , 2} = {{α}_{1} ( {ω}_{1} - {ω}_{2} )}^{1.8} ,$$

$${τ}_{2 , 3} = {{α}_{2} ( {ω}_{2} - {ω}_{3} )}^{1.8} ,$$

$${τ}_{3 , 4} = {{α}_{3} ( {ω}_{3} )}^{1.8} ,$$

Again, equating these expressions and rearranging twice gives

$${ω}_{2}^{N = 2} = \frac{{ω}_{1}}{1 + {( \frac{{α}_{2}}{{α}_{1}} )}^{1 / 1.8} ( 1 - \frac{1}{1 + {( \frac{{α}_{3}}{{α}_{2}} )}^{1 / 1.8}} )} ,$$

Comparing the expressions from ω₂ for the one and two shell layer cases, a clear pattern emerges and a general form for n shell layers may be derived as

$${ω}_{2}^{N = n} = {ω}_{1} ( \frac{{\sum }_{i = 2}^{n} {( {\prod }_{j = i}^{n} \frac{{α}_{j + 1}}{{α}_{j}} )}^{1 / 1.8} + 1}{{\sum }_{i = 1}^{n} {( {\prod }_{j = i}^{n} \frac{{α}_{j + 1}}{{α}_{j}} )}^{1 / 1.8} + 1} ) ,$$

and the frictional torque becomes,

$${τ}_{1 , 2}^{N = n} = {α}_{1} {ω}_{1}^{1.8} ( 1 - \frac{{\sum }_{i = 2}^{n} {( {\prod }_{j = i}^{n} \frac{{α}_{j + 1}}{{α}_{j}} )}^{1 / 1.8} + 1}{{\sum }_{i = 1}^{n} {( {\prod }_{j = i}^{n} \frac{{α}_{j + 1}}{{α}_{j}} )}^{1 / 1.8} + 1} ) ,$$

which has vastly improved properties in terms of reducing energy losses in the flywheel storage system.

A centripetal pressure is generated in fluid 110 as it rotates. In the layered drag reduction system illustrated in FIG. 6, each shell layer rotates at different speeds with the innermost rotating the fastest. This means that the centripetal pressure within the innermost layer is greater than the centripetal pressure within the layer encasing it, and so on. I.e., the centripetal pressure is not equal for each layer, and therefore each layer needs to contain a pressure difference across the layer.

Typically, flywheel rotors are cylindrical, as illustrated in FIG. 5, as are known shell layers for use with cylindrical rotors. Since pressure acts in all directions, the centripetal pressure creates a net force in a direction parallel to the axis of rotation (i.e., parallel to axle 100) that needs to be contained by the top and bottom surfaces of each shell layer. This can be achieved by simply increasing the thickness of material used for each shell layer, allowing each shell layer to resist the centripetal pressure with a bending moment. However, this approach may be uneconomical in many scenarios as it increases the material cost required for each shell layer. To address this, the inventors have found that by instead of providing flat top and bottom surfaces to the shell layers (as defined as those surfaces of the shell layer that intersect the axis of rotation), the provision of top and bottom surfaces comprising curves allows the generated centripetal pressure to be contained by tension within the material of the shell layer rather than as a bending moment, allowing the thickness of the materials to be reduced and thus reducing the material cost of the shell layers. Moreover, by reducing the required strength of the shell layers in this way, cheaper, more abundant materials can be used. Such an arrangement is illustrated in FIG. 6.

Broadly, improvements in the strength and material costs of the shell layers will be achieved by shell layers having a cross section which, when drawn in a plane in which the axis of rotation lies, defines a closed, substantially convex shape having top and bottom surfaces each comprising a continuous curve. As used herein, a shape is considered to be substantially convex if the ratio of the enclosed, internal area of the shape to the area of the smallest convex set that contains the shape is greater than 70%, preferably greater than 80%, and optimally greater than 90%. As used herein, a set of points is convex if the set contains the whole line segment that joins any given two points within the set. Alternatively, the cross section of the shell layer, when draw in the plane of the axis of rotation, may define a closed convex shape having top and bottom surfaces consisting of a continuous curve.

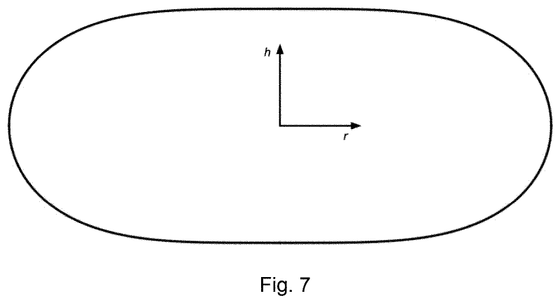

An example of the shape of the shell layer defined above is illustrated in FIG. 7, which represents the optimal shape of a shell layer to maximise strength and reduce material cost. This optimal shape is defined as

$$h ( r ) = \frac{1}{4} \frac{{r}^{4}}{{R}_{1}^{3}} 2 {F}^{1} ( \frac{1}{2} , \frac{2}{3} , \frac{5}{3} , {( \frac{r}{{R}_{1}} )}^{6} ) ,$$

where 2F¹ is the hypergeometric function. By evaluating this power series for the first few terms, the shape of FIG. 7 is found to have a height to radius ratio ~0.431.

To see how this shape is arrived at, and with reference to FIGS. 10A and 10B, the stresses that are exerted in both the azimuthal and polar directions of an asymmetrically shaped shell layer with an unknown curved shape, h(r), are considered. FIGS. 10A and 10B show the coordinates of the curved shell layer shape viewed in cross section in two different planes. Starting with coordinates from FIG. 10A, and taking a segment of the shell layer in the normal direction, we can write down an equation for equilibrium that defines the stress in this direction in the divider. This takes the following form

$$Prd θ {r}_{ϕ} d ϕ = {σ}_{ϕ} d ϕ trd θ + {σ}_{θ} d θ {tr}_{ϕ} d ϕ sin ϕ$$

where r=r_{θ} sin θ, r_{θ} is the length AB, r_{φ} is the length AC, t is the shell layer thickness,

$$P = \frac{1}{2} ρ {ω}^{2} {r}^{2}$$

is the centripetal pressure, and σ_{φ} and σ_{θ} are the shell layer stress in the φ and θ directions, respectively. Substituting in these definitions leads to the equation

$$\frac{P}{t} = \frac{{σ}_{ϕ}}{{r}_{ϕ}} + \frac{{σ}_{θ}}{{r}_{θ}}$$

Now with reference to FIG. 10B, an equation for equilibrium in this new direction can be found. The shell layer vertical force must be equal to the centripetal pressure in the vertical direction:

$$2 π tr {σ}_{ϕ} sin ϕ = \int P ( r ) dA .$$

Again, substituting in the above definitions leads to the equation

$$8 t {σ}_{ϕ} sin ϕ = {ρω}^{2} {r}^{3} .$$

Making use of two further definitions in terms of the differential elements,

$$sin ϕ = \frac{dh}{\sqrt{{dr}^{2} + {dh}^{2}}} and {r}_{ϕ} = \frac{{( 1 + {( \frac{dh}{dr} )}^{2} )}^{3 / 2}}{\frac{{d}^{2} h}{{dr}^{2}}} ,$$

two equations for the shell layer stresses in each of the 0 and 4 directions can be found:

$${σ}_{div , θ} = \frac{ρ {ω}^{2} {r}^{3}}{8 s} \frac{1}{\sqrt{1 + {( \frac{dr}{dh} )}^{2}}}$$

$${σ}_{div , ϕ} = \frac{ρ {ω}^{2} {r}^{3}}{8 s} \frac{1}{\sqrt{1 + {( \frac{dr}{dh} )}^{2}}} ( 4 - \frac{r \frac{{d}^{2} h}{{dr}^{2}}}{\frac{dh}{dr} ( 1 + {( \frac{dh}{dr} )}^{2} )} )$$

An optimal shape will produce a constant stress in both directions according to these two equations. As indicated above, a solution can be found having the form

$$h ( r ) = \frac{1}{4} \frac{{r}^{4}}{{R}_{1}^{3}} {}_{2} {F}_{1} ( \frac{1}{2} , \frac{2}{3} , \frac{5}{3} , {( \frac{r}{{R}_{1}} )}^{6} ) .$$

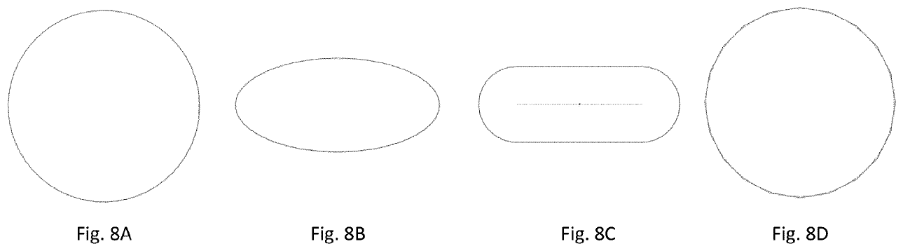

While the shape of FIG. 7, as defined above, has been found to be optimal for reducing material cost and maximising strength, alternative shapes are also possible. Four examples of such shapes are illustrated in FIGS. 8A to D. While these shapes are not optimal, and would require increased wall thickness and accordingly would incur higher material costs when manufacturing, they would still function to contain the centripetal pressure generated as the fluid within them rotates, and may be economical in certain scenarios. As shown, the cross section of the shell layers in the plane of the axis of rotation may alternatively form a circle, an ellipse, a slot (i.e. a shape defined by the set of all points that lie at an equal distance from a line of a given length), and a convex polygon, for example, a rectangle. Alternatively, although not shown in FIGS. 8A to D, the shell layers may define a cylinder having domed top and bottom surfaces. As will be appreciated, the disclosed shell layer technique will also provide improvements in drag reduction for any shape shell layer, despite certain shapes being less economical when required to contain a centripetal pressure as outlined above. As such, further alternatively, each shell layer may be a cylinder having flat top and bottom surfaces.

Returning to FIG. 6, in the illustrated example each of the shell layers 123 and 124 have substantially the same, optimal shape as defined above with reference to FIG. 7. Similarly, the rotor 122 defines an outer surface conforming to the shape of innermost shell layer 123. This arrangement ensures that the mass of the rotor, and hence energy storage capacity, is maximised for a given volume defined by innermost shell layer 123. However, this need not be the case and the rotor may have a different shape to that defined by the shell layers as the structural requirements on the rotor are different to those of the shell layers. For example, the rotor may be shaped as a laval disc having reduced cross section with radius to maintain the same stress in all parts of the disk, while the shell layers may have the optimal shape defined above in order to maximise strength of the shell layers while minimising material cost.

In order to reduce the required strength and rigidity of the shell layers while still ensuring that the shell layers conform to a desired shape while in use, shell layers 123 and 124 may be constructed of a resiliently deformable material and define a second shape when stationary. This second shape can be chosen such that, when shell layers are rotating and operating with the centripetal pressure generated by the contained rotating fluid 110, the centripetal pressure causes the shell layers to deform from the second shape into the first desired shape. In this way, it can be ensured that the shell layers define a desired shape when rotating without having to be constructed of unnecessarily rigid materials to prevent any deformation as a result of the generated centripetal pressure.

The centripetal pressure generated by fluid 110 increases with increased rotational velocity. Accordingly, at lower rotational speeds, for example as the flywheel is spinning up or slowing down, the centripetal pressure acting on the shell layer may be lower than the force acting on the shell layer due to gravity. In this scenario, the shell layer may sag towards the second shape and towards rotor 122 under the force of gravity as illustrated by the dotted line in FIG. 11. As shown at points A and B in FIG. 11, this sagging increases the risk of contact between shell layer 124 and rotor 122. Such contact may result in friction between rotor 122 and shell layer 124, which can reduce the storage efficiency by converting rotational kinetic energy into heat. Moreover, rubbing between the rotor and shell layer may damage one or both of rotor 122 and shell layer 124.

Accordingly, there are described below a number of support features to inhibit deformation of the shell layer towards the rotor, or indeed deformation between a given shell layer and the shell layer nested inside it in embodiments comprising multiple shell layers. While a number of embodiments are described below with respect to a shell layer and rotor, each of these is equally applicable to prevent contact between a given shell layer and the shell layer nested within it.

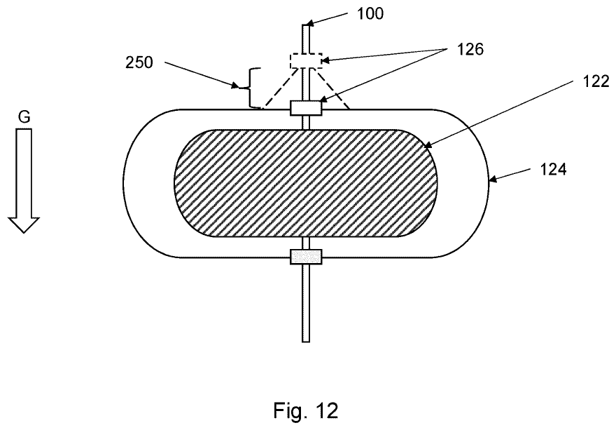

FIG. 12 illustrates a first embodiment of a support feature for inhibiting deformation of shell layer 124. As illustrated, the support feature may comprise a portion 250 of the top surface of the shell layer. In the embodiment illustrated in FIG. 12, portion 250 comprises a section of the top surface being deflected away from rotor 122 proximate to the centre of rotation. To accommodate this deflection, shell layer bearing 126 has likewise been moved along axle 100 away from rotor 122. This results in portion 250 including a component parallel to the direction of gravity, as denoted by arrow G. More precisely, a tangent to a point on the surface of portion 250, when decomposed into orthogonal vectors defined as parallel and normal to G, will include a non-zero component parallel to G. As such, the shell layer itself can support the weight of the shell layer as tension in portion 250, thereby inhibiting deformation of the shell layer towards the rotor. Alternatively, portion 250 may comprise a section of the shell layer being deflected towards the rotor, thereby allowing portion 250 to support the weight of shell layer via compression.

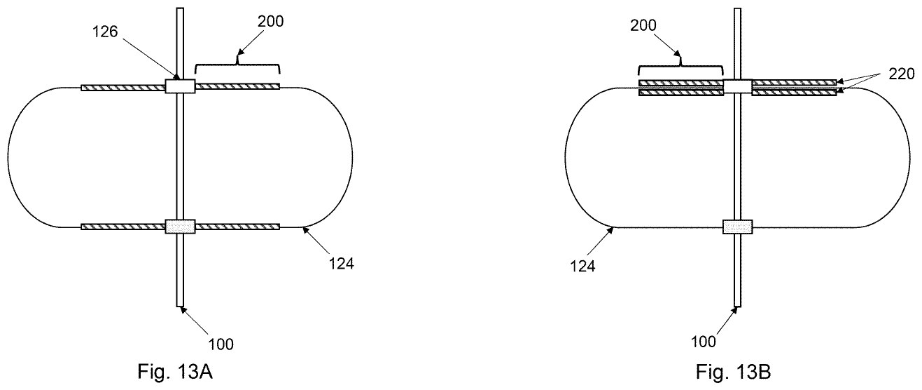

FIGS. 13A and 13B illustrate further embodiments of a support feature for inhibiting deformation of a shell layer. As illustrated, the support feature may comprise reinforced section 200 of shell layer 124. As shown in FIG. 13A, reinforced section 200 may comprise a section of shell layer adjacent to bearing 126 having increased thickness, thereby increasing the stiffness of the material and allowing the reinforced section to inhibit deformation of shell layer 124 towards the rotor. As used herein, “thickness” is measured in a direction normal to the surface of the shell layer. In the illustrated example of FIG. 13A, reinforced section comprises a section of uniform thickness, however in alternative embodiments the reinforced section may have non-uniform thickness. For example, the thickness of reinforced section 200 may decrease with increased distance from bearing 126. Such a decrease in thickness may be linear or non-linear. For example, the thickness of reinforced section 200 may decrease in a stepwise manner, or may decrease in proportion to distance from the bearing squared, cubed, or any other non-linear function of distance.

Reinforced section 200 may additionally or alternatively be constructed of a different material to the remainder of the shell layer, such that the material used for reinforced section 200 is stiffer than the material of the remainder of the shell layer. As used herein, stiffness refers to the ability of a material to resist deformation in response to an applied force. For example, reinforced section may be constructed of composite materials, such as fibre glass or carbon fibre.

As shown in FIG. 13B, reinforced section 200 may additionally or alternatively comprise a reinforcing structure coupled to a surface of the shell layer. In the illustrated example, reinforced section 200 comprises on or more reinforcing plates 220 coupled to the top surface of the shell layer adjacent to bearing 126. Reinforcing plates may be made of the same or a different material to shell layer 124. Hence, reinforcing plates may improve the stiffness of reinforced section 200 either by increasing the thickness of reinforced section, or additionally by being made of a material of intrinsically higher stiffness than the remainder of the shell layer. By coupling reinforcing plates 220 to shell layer, the stiffness of reinforced section is increased, thereby inhibiting deformation of the shell layer under gravity. Furthermore, as shown in FIG. 13B, reinforcing plates may sandwich shell layer by being coupled to both the outer and inner surfaces of shell layer adjacent to bearing 126. While illustrated as reinforcing plates in FIG. 13B, reinforcing structure may take alternative forms. For example, reinforcing structure may comprise reinforcing bars, beams, rods, trusses, or brackets coupled to one or more surfaces of shell layer 124. Additionally, while illustrated as coupled to a surface of the shell layer, reinforcing structure may alternatively be embedded in the shell layer.

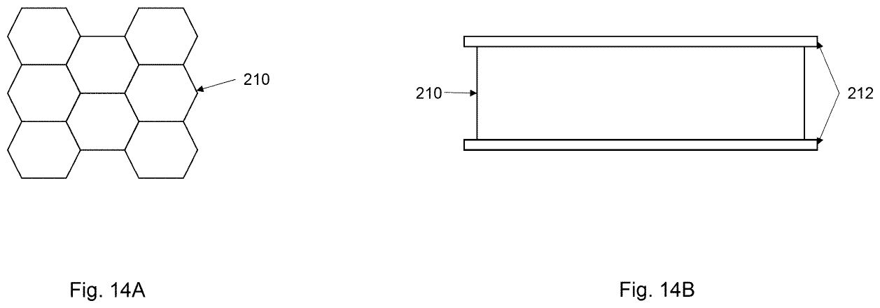

FIGS. 14A and 14B illustrate further embodiments of a support feature, wherein the support feature comprises a section of the shell layer having a different material structure to the remainder of the shell layer. As used herein, a “material structure” is the macroscopic arrangement of the material. As illustrated by FIG. 14A, the material structure may comprise a repeated cell structure. In the specific example of FIG. 14A, the repeated cell structure comprises a pattern of repeated hollow tubular hexagonal cells, for example a “honeycomb” structure. By providing a material with a repeated cell structure, such as that illustrated by FIG. 14A, the stiffness of the material can be improved with a lower increase in weight than a correspondingly thick solid material.

An example of a material suitable for use as a support feature comprising the repeated cell structure of FIG. 14A is illustrated in FIG. 14B. As shown, material 210 having the repeated cell structure is sandwiched between top and bottom plates 212. As illustrated in FIG. 14B, the axis of the hexagonal tubes defined by the cell structure shown in FIG. 14A runs perpendicular to the top and bottom plates 212.

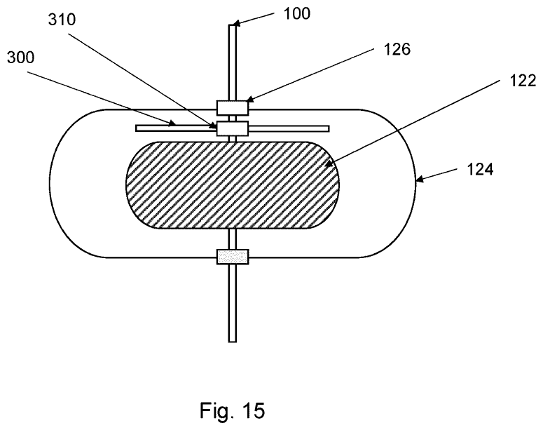

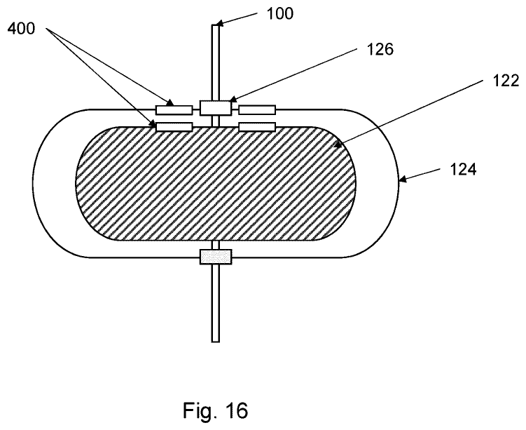

FIG. 15 illustrates a support feature comprising a support structure. In the illustrated example, support structure comprises a support plate 300 coupled to axle 100 via support bearing 310. FIG. 15 illustrates shell layer 124 occupying the first shape, i.e., its shape during steady state operation. As shown in FIG. 15, when in the first shape, the shell layer does not contact support plate 300, allowing support plate 300 and shell layer 124 to rotate freely relative to one another. However, when the rotational speed of shell layer 124 drops, the centripetal pressure of fluid contained within shell layer drops and the shell layer begins to sag under gravity towards the second shape. As shell layer 124 sags, shell layer is configured to come into contact with support plate 300, which supports shell layer 124 and prevents further deformation of shell layer 124 towards rotor 122. In this way, support plate 300 prevents shell layer coming into contact with rotor 122. Moreover, as support plate 300 can freely rotate on bearing 310, plate 300 matches the speed of shell layer 124 as they come into contact, thereby minimising slipping and friction between shell layer 124 and plate 300.

While FIG. 14 illustrates support plate 300 being freely rotatable relative to shell layer 124 via bearing 310, in alternative embodiments support plate 300 may instead be coupled to bearing 126 and hence configured to always rotate with shell layer 124. Such an embodiment may ensure that there is no slip or friction between the shell layer and plate as the shell layer sags into contact with support plate 300.

While FIG. 14 illustrates support structure as a support plate, support structure may take alternative forms, such as one or more support beams, rods, bars, trusses or brackets.

Turning to FIG. 16, in alternative embodiments the support feature may comprise a pair of magnets that are configured to inhibit deformation of the shell layer via magnetic repulsion between the pair of magnets. As illustrated, a first magnet of the pair of magnets may be coupled to a top surface of rotor 122, while a second magnet may be coupled to the top surface of shell layer, such that the pair of magnets are facing each other. In this embodiment, the magnets are polarised such that like poles face each other. Accordingly, as shell layer 124 decelerates and begins to sag under gravity, first and second magnets approach and repel each other, thereby inhibiting further deflection of shell layer 124 towards rotor 122.

In the illustrated example, the first and second magnets of pair 400 are illustrated as ring magnets and are shown in cross section in FIG. 16. However, the first and second magnets may take any suitable form. For example, each of first and second magnet may be an arc, bar, rod, disc, horseshoe, channel, or block magnet. Furthermore, first and second magnets may take different forms to one another. Furthermore, magnets 400 may be permanent magnets, or they may be selectively activatable electromagnets.

In addition, embodiments of the present invention may include more than one pair of magnets. For example, a plurality of opposing pairs of magnets may extend across the top surface of the rotor and shell layer to inhibit deformation of the shell layer towards the rotor across the entire length of the top surface.

Finally, as illustrated in 17, the shell layer may alternatively or additionally be configured to resist deformation towards the rotor under the influence of gravity by instead being mounted with its axis of rotation perpendicular to the direction of gravity. For example, axle 100 may be configured to couple to housing 20 such that axle 100 is parallel to a plane defined by mudmat 32. By installing the rotor in this way, the shell layer acts as an arch, allowing the weight of the shell layer to be supported by compression across the curved surface of the shell layer.

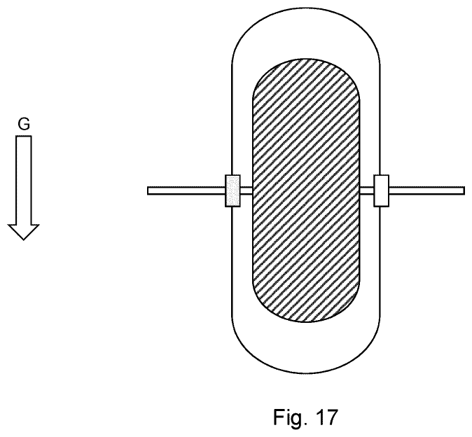

While the above support features have been illustrated in FIGS. 11 to 17 with respect to shell layers comprising top and bottom surfaces comprising a continuous curve, it will be appreciated that the support features are equally applicable to alternative shell layer shapes. For example, the support features described above can be applied to each of the shell layer shapes illustrated in FIGS. 8A to 8D, as well as alternative cross sections, such as other convex polygons—for example a rectangle. The support features could likewise be applied to shell layers in the form of a cylinder having domed top and bottom surfaces, as well as cylinders having flat top and bottom surfaces.

1. (canceled)

2. A flywheel energy storage device comprising:
a housing, wherein the housing is sealed to separate an interior of the housing from an external environment;
a rotor mounted on an axle within the housing, the rotor configured to rotate relative to the housing;
a fluid contained within the housing to compress the rotor;
means for maintaining the pressure of the fluid substantially at equilibrium with or greater than the pressure of the external environment; and
wherein the housing is a pressure vessel only capable of withstanding a pressure less than the pressure of the fluid.

3. The energy storage device of claim 2, further comprising one or more of:
an electric motor coupled to the axle for storing energy in the flywheel energy storage device; and
a generator coupled to the axle for extracting energy from the flywheel energy storage device.

4. The energy storage device of claim 2, wherein one or more of the housing and the rotor is constructed of a low tensile strength material.

5. The energy storage device of claim 4, wherein the low tensile strength material of the housing has a tensile strength of less than 200 Mpa.

6. The energy storage device of claim 2, wherein the rotor is made of a ceramic.

7. The energy storage device of claim 2, wherein the rotor is made of a granular material encased within a sealed vessel, wherein the pressure within the vessel is maintained at a pressure less than the pressure of the fluid.

8. The energy storage device of claim 2, wherein the means for maintaining the pressure comprise one or more of: a pressure compensator coupled to the pressure of the external environment; and a valve system coupled to a source of pressurised fluid.

9. The energy storage device of claim 2, wherein the housing is sealed using one or more seals for separating sea water from the fluid.

10. The energy storage device of claim 2, wherein the fluid is a low-density fluid, and optionally wherein the density of the fluid at operating pressure is less than one third of the density of the rotor.

11. The energy storage device of claim 2, further comprising an electrical connector comprising a conductor for electrical communication with the energy storage device, wherein the electrical connector comprises means to isolate the conductor from sea water, optionally wherein the means comprises one or more of a seal and a dielectric fluid.

12. The energy storage device of claim 2, further comprising control electronics, and comprising means to isolate the control electronics from the external environment, optionally wherein the means for isolating the control electronics comprise: a sealed, air-filled canister for protecting the control electronics from sea water.

13. The energy storage device of claim 2, further comprising a lifting attachment for lowering the energy storage device into position underwater.

14. The energy storage device of claim 2, wherein the housing is configured for connection to a foundation anchor to support and stabilize the energy storage device in location, and optionally wherein the foundation anchor is one or more of: a mudmat, a caisson, or one or more piles.

15. The energy storage device of claim 2, further comprising a shell layer encasing the rotor and coupled to the axle via a bearing, the shell layer having a first shape, wherein the bearing allows the shell layer to rotate around the rotor about an axis of rotation that is concentric with the axle.

16. A rotor for use in a flywheel energy storage device, the rotor comprising:
a rotor;
an axle coupled to the rotor;
a shell layer encasing the rotor and coupled to the axle via a bearing, the shell layer having a first shape, wherein the bearing allows the shell layer to rotate around the rotor about an axis of rotation that is concentric with the axle, and wherein at least one of the following conditions apply:
the cross section of the shell layer, when drawn in a plane in which the axis of rotation lies, defines a closed, substantially convex shape having top and bottom surfaces that intersect the axis of rotation, and wherein each of the top and bottom surfaces comprise a continuous curve; and
the shell layer defines a closed three dimensional, substantially convex shape having top and bottom surfaces that intersect the axis of rotation, and wherein each of the top and bottom surfaces comprise a portion having continuous curvature.

17. (canceled)

18. The rotor of claim 16, comprising a plurality of concentrically nested shell layers, wherein each shell layer has a corresponding first shape, each shell layer comprising a bearing coupled to the axle, wherein the bearing is configured to allow the shell layer to rotate around the rotor, and to rotate relative to each of the other shell layers.

19. The rotor of claim 18, wherein the gap between shell layers is less than 20% of the diameter of the rotor.

20. The the rotor of claim 16, wherein the first shape of the shell layer is defined by a hypergeometric function.

21. The rotor of claim 16, wherein the first shape of the shell layer is one of: a sphere, an ellipsoid, and a cylinder having domed top and bottom surfaces.

22. The rotor of claim 16, wherein the shape of the rotor corresponds to the first shape of the shell layer.

23. The rotor of claim 16, wherein the shell layer is resiliently deformable and comprises a second shape when stationary, and wherein the shell is configured to deform when rotating into the first shape.

24. The rotor of claim 23, further comprising a support feature configured to inhibit deformation of the shell layer towards the rotor.

25. The rotor of claim 24, wherein the support feature comprises a portion of the top surface of the shell layer, wherein the portion of the top surface of the shell layer extends away from the rotor to couple to the bearing.

26. The rotor of claim 24, wherein the support feature comprises a reinforced section of the shell layer.

27. The rotor of claim 26, wherein the reinforced section of the shell layer comprises one or more of:
a section of the shell layer having increased thickness;
a section of the shell layer being constructed of a different material to the remainder of the shell layer; and
a reinforcing structure coupled to a surface of the shell layer.

28. The rotor of claim 24, wherein the support feature comprises a section of the shell layer having a different material structure than the remainder of the shell layer.

29. The rotor of claim 28, wherein the section of the shell layer having a different material structure comprises a material formed into a repeated cell structure.

30. The rotor of claim 24, wherein the support feature comprises a support structure, wherein the shell layer is configured to contact the support structure when the shell layer is in the second shape, and wherein the shell layer is configured to move away from the support structure as the shell layer deforms into the first shape.

31. The rotor of claim 30, wherein the support structure is coupled to the axle and configured to rotate with the shell layer.

32. The rotor of claim 24, wherein the support feature comprises a pair of magnets, wherein the pair of magnets are configured to inhibit deformation of the shell layer towards the rotor via magnetic repulsion between the pair of magnets.

33. The rotor of claim 24, wherein the support feature is located proximate to the axis of rotation.

34. (canceled)

35. A method for generating electricity using the flywheel energy storage device of claim 2, the method comprising;
using the rotor to turn a generator coupled to the axle of the storage device.
